(19) United States
(12) Patent Application Publication
(10) Pub. No.: US 2008/0023636 A1
(43) Pub. Date: Jan. 31, 2008

(54) Tungsten polymer collimator for medical imaging

(76) Inventors: Samir Chowdhury, Chicago, IL (US); Jinhun Joung, Algonquin, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/492,357

(22) Filed: Jul. 25, 2006

(51) Int. Cl. G21K 1/02

(52) U.S. Cl. 250/363.1

(57) ABSTRACT

A collimator for a nuclear imaging device includes, i.e., is formed from, a tungsten polymer. Preferably, the tungsten polymer includes at least 50% by weight of tungsten powdered tungsten mixed with polymer and has a density substantially equivalent to that of lead. Preferably, the collimator includes at least one of a slat, a parallel hole, a pinhole, a multi-pinhole, a square hole, a hexagonal hole, a fan beam, a diverging and a converging beam type-collimator. Preferably, the collimator has a thickness from 0.01 to 1.1 cm and a photon stopping power of from 0.5 to 50% for stopping photons having energy levels from 50 to 200 keV.

### FIELD OF THE INVENTION

The present invention generally relates to nuclear imaging devices. More specifically, the present invention relates to collimators for a nuclear imaging device comprising a tungsten polymer.

### BACKGROUND OF THE INVENTION

Generally, in conventional nuclear imaging devices, collimators are used for directing and/or permitting only certain particles/beams of radiation traveling along particular paths, to pass through to interact with a detector, such as a scintillation crystal. In this regard, collimators are used in nuclear imaging devices, such as planar and SPECT gamma cameras, to ensure that only certain radiative particles/beams passing along certain paths from known radiation sources, strike the detectors of the imaging devices. Collimators, therefore, act to minimize the detection of undesired, scattered particles/beams, or particles/beams emanating from secondary sources of radiation.

In nuclear imaging devices used for medical diagnostic analysis, or for non-destructive evaluation procedures, it is important that only those radiative particles that emanate from a known radiation source, and which passes along a direct path, be detected and processed by the detectors. If the detector is struck by undesired radiation, such as that passing along non-direct routes to the detector, performance of the imaging system can be degraded, which can ultimately affect image quality.

Typically, collimators are selectively positioned to absorb radiation before it reaches the detector and are usually fabricated from a relatively high atomic number material, such as lead. In many detector systems, the collimator includes barriers associated with the detector, which are disposed in the direction of the radiation source.

For example, in Single Photon Emission Computed Tomography (SPECT), a collimator having apertures therein can be positioned between the detector and the subject to be imaged in order to screen out substantially all radioactive rays, except those that are directed along certain paths through the collimating apertures. Traditionally, collimators are made from radiation opaque materials, such as a heavy metals, and the collimating apertures therein formed by various means, such as drilling.

Generally, single photon imaging, either planar or SPECT, requires the use of a collimator placed in front of a scintillation crystal or solid state detector, to allow only those radiative particles (e.g., gamma photons) aligned with the apertures of the collimator to pass to the detector, thus inferring the line on which the gamma emission is assumed to have occurred. Single photon imaging techniques require gamma ray detectors that calculate and store both the position of the detected gamma ray and its energy.

Two types of collimators that are principally utilized include the parallel-hole collimator and the pinhole collimator. Typically, parallel-hole collimators contain hundreds of parallel holes drilled or etched into a very dense material, such as lead, and accept only those photons that travel perpendicular to the surface of a detector, e.g., a scintillating detector, and produce a planar image of the object that is the same size as the source object. In general, the resolution of parallel-hole collimators increases as the holes are made smaller in diameter and longer in length. Conventional pinhole collimators, on the other hand, are usually cone-shaped and have a single small hole drilled in the center of the collimator material. Pinhole collimators generate a magnified image of an object in accordance with the collimator's acceptance angle, and are primarily used for studying small organs, such as the thyroid, or localized objects, such as joints. Pinhole collimators must be placed at a very small distance from the object being imaged in order to achieve acceptable image quality. Pinhole collimators offer the benefit of high magnification of a single object, but lose resolution and sensitivity as the field of view (FOV) gets wider and the object is farther away from the pinhole.

Other known types of collimators include the slant-hole collimator, converging and diverging collimators, and the fan beam collimator. Slant-hole collimators are variations of the parallel-hole collimator, but with all holes slanted at a specific angle. This type of collimator is positioned close to the body and produces an oblique view for better visualization of, for example, an organ whose line of sight may be partially blocked by other parts of the body. The converging collimator has holes that are not parallel with respect to one another, but instead are focused toward the organ, with the focal point being located in the center of the field of view. The image appears larger at the face of the scintillating detector using a converging collimator. A diverging collimator results by reversing the direction of the converging collimator. The diverging collimator is typically used to enlarge the FOV, such as would be necessary with a portable camera having a small scintillator. The fan beam collimator is typically used with a rectangular camera head to image smaller organs. The holes are parallel when viewed from one direction and converge when viewed from another direction. The fan beam collimator allows the maximum surface of the crystal to be used to capture imaging data. In most applications, the choice of collimation represents a trade-off between the size of the FOV and the sensitivity and spatial resolution required to properly visualize the target object or organ.

Conventional single photon imaging systems with parallel-hole collimation use large area (on the order of 2000 cm²) monolithic scintillation detectors, and typically have an intrinsic spatial resolution of approximately 3.5 mm FWHM (Full Width Half Maximum). Such detectors are made either of sodium iodide crystals doped with thallium (NaI(Tl)), or cesium iodide (CsI). Scintillations within the NaI crystal caused by absorption of a gamma photon within the crystal, result in the emission of a number of light photons from the crystal. The scintillations are detected by an array of photomultiplier tubes (PMTs) in close optical coupling to the crystal surface.

The intrinsic spatial resolution is primarily determined by the size of the PMTs. The design of the parallel-hole collimator (i.e., the length and diameter of the collimator holes) fixes the system resolution, and represents a trade-off between sensitivity (i.e., the number of detected gamma rays) and spatial resolution (i.e., sharpness of the image) of the imaged target object. The system spatial resolution is a quadrature sum of the geometric resolution of the collimator and the intrinsic resolution of the camera. In most clinical imaging studies, the predominant spatial resolution achieved is determined by the geometric resolution of the collimator, and thus there has not been a strong incentive to increase the intrinsic spatial resolution of the gamma camera.

As previously indicated, in conventional nuclear imaging systems, collimators are fabricated from lead, which is capable of absorbing radiative particles, and which, when used in large volumes, is very cost effective. However, there are problems associated with collimators fabricated from lead. For one, collimators made from lead can be heavy. Additionally, lead is relatively malleable and it can be difficult to form complex collimator structures having specific configurations, e.g., sharp angles. Also, because of its malleability, collimators made from lead must be handled with care so as to avoid damage to the collimators. Moreover, the use of lead as a collimator material limits the methods by which collimators may be fabricated, i.e., it can be difficult to machine lead. Further, numerous precautions must be taken in the fabrication of lead collimators and their use so as to avoid exposure because of the known adverse health consequences associated with lead.

What is needed is a collimator that addresses the above, and other problems associated with known collimators. It should be appreciated that the problems enumerated in the foregoing are not intended to be exhaustive, but rather among many which tend to impair the effectiveness of previously known collimators. Other noteworthy problems may also exist; however, those presented above should be sufficient to demonstrate that collimators known in the art have not been altogether satisfactory.

### SUMMARY OF THE INVENTION

A collimator for a nuclear imaging device comprises a tungsten polymer. In one embodiment, the tungsten polymer collimator is alone or in combination one of the following types of collimators; slat, parallel hole, pinhole, multipinhole, square hole, hexagonal hole, fan beam, diverging or converging. In another embodiment, the tungsten polymer collimator has a thickness of from 0.01 to 1.1 cm. In yet another embodiment, the tungsten polymer collimator has a photon stopping power of from 0.5 to 50%. In still another embodiment, the tungsten polymer collimator is configured for stopping photons having energy levels from 50 to 200 keV. In yet still another embodiment, the tungsten polymer collimator has a stopping power of from 0.5-50% when a photon has an energy of from 50 to 200 keV and the thickness of the collimator is between 0.01 to 1.0 cm. In a further embodiment, the tungsten polymer collimator is non-toxic.

In others embodiments, an existing nuclear imaging device filters photons with a tungsten polymer collimator.

### BRIEF DESCRIPTION OF THE DRAWINGS

The invention is pointed out with particularity in the claims. The above and further advantages of this invention may be better understood by referring to the following description taken in conjunction with the accompanying drawings, in which:

FIG. 1 is a perspective view of a slat collimator in accordance with an embodiment of the present invention;

FIG. 2 is a plan view of a multi-pinhole collimator in accordance with an embodiment of the present invention;

FIG. 3 shows a parallel-hole collimator in accordance with an embodiment of the present invention;

FIG. 4 shows a fan-beam collimator in accordance with an embodiment of the present invention;

FIG. 5 is an illustration of an example of a tungsten polymer matrix used for fabricating a tungsten polymer collimator according to an embodiment of the present invention;

FIG. 6a is a graph depicting photon stopping power of a tungsten collimator in accordance with an embodiment of the present invention;

FIG. 6b is a graph depicting photon stopping power of a lead collimator in accordance with the prior art; and

FIG. 6c is a graph depicting photon stopping power of a tungsten polymer collimator in accordance with an embodiment of the present invention.

### DETAILED DESCRIPTION OF EXEMPLARY EMBODIMENTS

A tungsten polymer collimator according to an exemplary embodiment of the instant invention is intended to substantially accomplish the foregoing objectives.

Examples of the more important features of this invention have thus been summarized rather broadly in order that the detailed description thereof that follows may be better understood and in order that the contribution to the art may be better understood. There are, of course, additional features of the invention that will be described hereinafter and which will also form the subject of the claims.

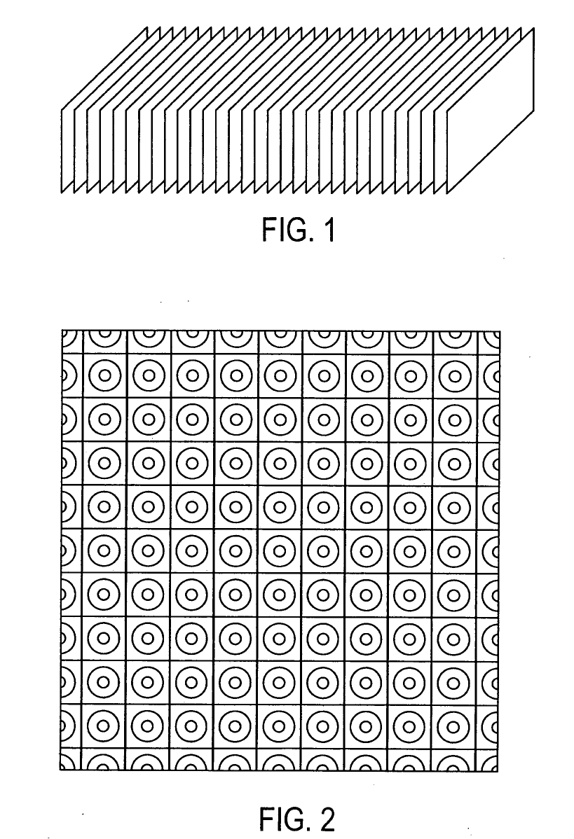

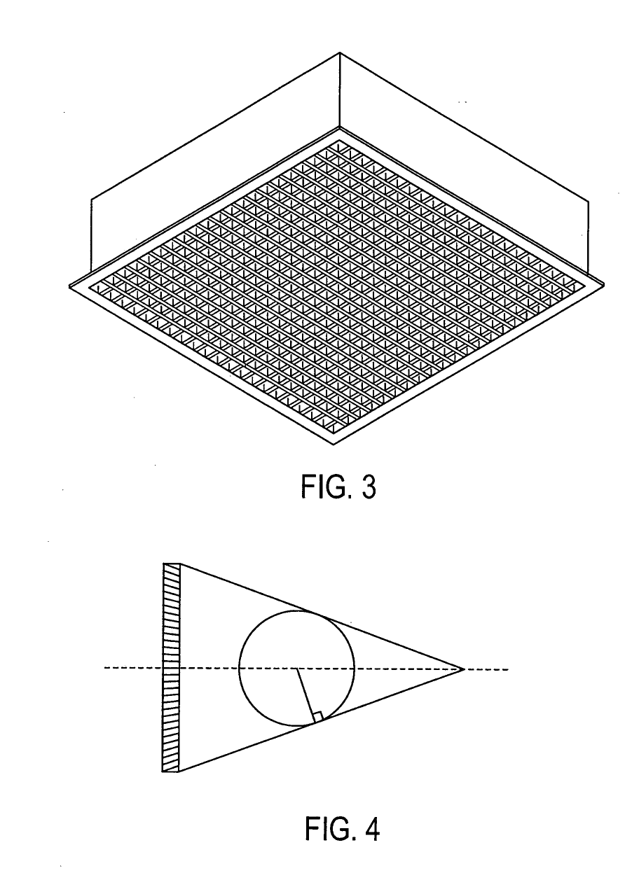

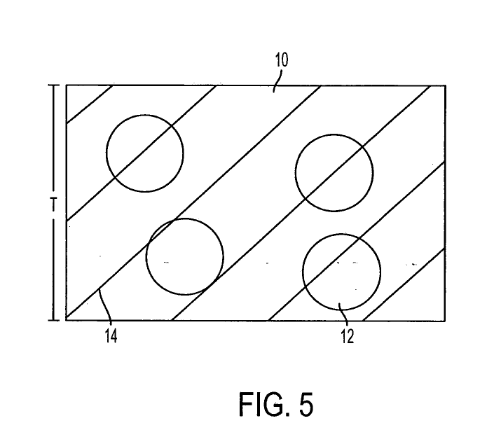

Referring now to the figures, FIGS. 1-4 illustrate examples of slat, multiple pinhole, parallel hole and fan-beam collimators which may be formed in accordance with an embodiment of the present invention. A tungsten polymer collimator fabricated according to an embodiment of the present invention can comprise complex structures and can be fabricated using one of the many fabrication processes that are generally available for polymers. Furthermore, the use of tungsten polymer allows the collimators to more readily undergo post fabrication procedures that may be required to form complex structures. For example, because it is not as malleable as lead and is non-toxic, tungsten polymer collimators according to the invention can be subjected to procedures such as milling, drilling, sanding, etc. that may not be available for lead.

For example, in accordance with the invention as shown in FIG. 5 a tungsten polymer for forming a collimator 10 can comprise tungsten 12 and a binder material 14. In an embodiment, the tungsten polymer comprises at least 40% tungsten by weight. In further embodiments, the tungsten polymer comprises at least 50% of tungsten by weight. In still further embodiments, the tungsten polymer comprises at least 60% of tungsten by weight. In yet still further embodiments, the tungsten polymer comprises at least 70% of tungsten by weight. In other embodiments, the tungsten polymer comprises at least 80% of tungsten by weight. In still other embodiments, the tungsten polymer comprises at least 90% of tungsten by weight. It should be appreciated that the term/phrase “tungsten” and related terms/phrases are intended to describe a tungsten polymer comprising tungsten regardless of it physical state. That is, the tungsten comprising the tungsten polymer collimator can comprise a powdered form, small particles, or filings, etc. Similarly, “tungsten” can include tungsten alone, or compositions containing tungsten. Suitable polymers binders in a preferred embodiment can comprise polyvinyl chloride, polyethylene, polyester, polytetrafluoroethylene, polyurethane, polypropylene, acrylonitrile butadiene Styrene, acetal, nylon, styrene and copolymers thereof.

In a further preferred embodiment, a tungsten polymer collimator can be formed to have a thickness T of from 0.01 to 1.1 cm. In other embodiments, the tungsten collimator thickness T is from 0.1 to 1.0 cm. In still another embodiment, the tungsten collimator has a thickness T of from 0.2 to 0.9 cm. In yet still another embodiment, the tungsten collimator T has a thickness of from 0.3 to 0.8 cm. In a further embodiment, the tungsten collimator has a thickness T of from 0.4 to 0.7 cm. In a yet further embodiment, the tungsten collimator has a thickness T of from 0.5 to 0.6 cm.

A method for fabricating a tungsten polymer collimator can comprise mixing tungsten powder, small particles and/or filings, etc. with a polymer binder using known methods for fabricating polymers to form a tungsten polymer wherein the tungsten is essentially locked within the polymer. In some embodiments, the tungsten and polymer can be mixed to homogenously distribute the tungsten throughout the polymer binder. Thereafter, the tungsten polymer can be submitted to a polymer fabrication process so as to form a collimator. Examples of fabrication methods include, but are not limited to: molding, extruding, machining, forming, rolling and bonding.

Preferably, the tungsten polymer collimator has a density that substantially equivalent to lead and is between 8 and 12 g/cc. In other embodiments, the tungsten polymer collimator has a density between 9 and 11 g/cc. In yet other embodiments, the tungsten polymer has a density of 10 g/cc.

It will be recognized by those skilled in the art from this disclosure that a tungsten polymer collimator according to the invention can be fabricated to any of a slat, parallel hole, pinhole, multi-pinhole, square hole, hexagonal hole, fan beam, diverging and converging beam collimator, or combinations thereof. Furthermore, as previously indicated, the use of tungsten polymer allows the collimators to more readily undergo post fabrication procedures that may be required to form complex structures. For example, because it is not as malleable as lead and is non-toxic, tungsten polymer collimators can be subjected to procedures such as milling, drilling, sanding, etc., which may not be available for lead collimators.

In a preferred embodiment, a tungsten polymer collimator according to the invention is configured for use with a nuclear imaging device, such as a PET or SPECT imaging device, and is capable of preventing amounts radiative particles from colliding with a detector assembly thereof. In one embodiment, a tungsten polymer collimator for a nuclear imaging device has at least 50% by weight of tungsten. In such embodiment, the tungsten polymer is formed by mixing powdered tungsten with a polymer such that the tungsten polymer has a density between 9-12 g/cc. In some embodiments the tungsten collimator can be configured to comprise a photon stopping power of 0.05 to 50%. In some embodiments, when the thickness of the collimator is between 0.01 to 1.0 cm and photons having energy levels from 50 to 200 keV are directed toward the collimator, the tungsten polymer collimator has a stopping power of from 0.5 to 50%. In other embodiments the tungsten collimator can be configured to have a photon stopping power of from 10 to 40%. In some embodiments, the tungsten collimator can have a photon stopping power of from 20 to 30%. In still other embodiments, a tungsten polymer collimator can be configured for stopping photons having energy levels from 50 to 200 keV. In other embodiments, the tungsten polymer collimator can be configured for stopping photons having energy levels from 100 to 150 keV.

### EXPERIMENTAL EXAMPLE

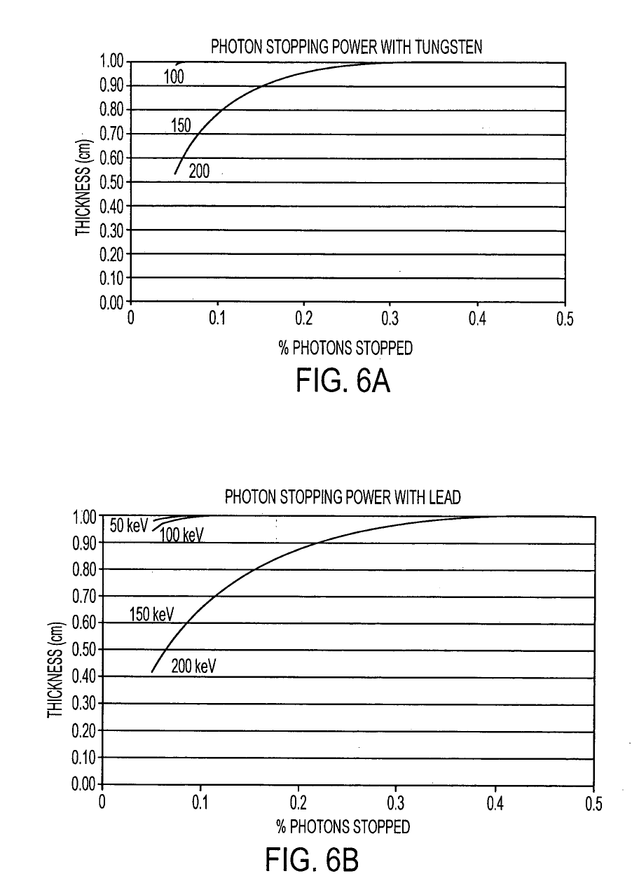

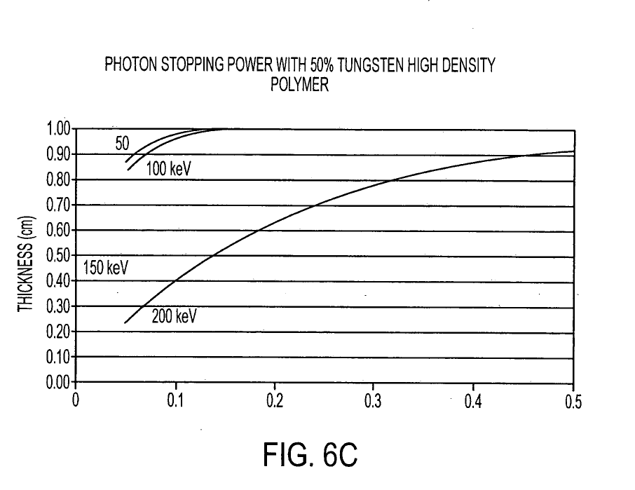

Referring now to FIGS. 6a-6c, which are graphical illustrations comparing a tungsten polymer collimator according to the invention, a lead collimator and a tungsten collimator. As can be seen, a collimator made from 50% tungsten high density polymer according to the invention was compared to known tungsten and lead collimators for photon stopping power. The experimental data shows that a 50% tungsten high density polymer collimator, unexpectedly, has a greater photon stopping ability than a tungsten or lead collimator. For example, the tungsten high density polymer unexpectedly stops, at a thickness of 0.40 cm, 10% of photons at 200 keV whereas the tungsten and lead collimators require thicknesses of 0.80 cm and 0.65 cm, respectively, to achieve 10% of photons stopped.

It is understood that while the invention has been described in conjunction with the detailed description thereof, the foregoing description is intended to illustrate and not limit the scope of the invention, which is define by the scope of the appended claims. Other aspects, advantages and modifications are within the scope of the following claims.

What is claimed is:

1. A collimator for a nuclear imaging device comprising tungsten polymer.

2. The collimator of claim 1 wherein said tungsten polymer comprises at least 50% by weight of tungsten.

3. The collimator of claim 2 wherein said tungsten is powdered.

4. The collimator of claim 1 wherein said tungsten polymer has a density substantially equivalent to that of lead.

5. The collimator of claim 4 wherein said tungsten polymer has a density between 8 and 12 g/cc.

6. The collimator of claim 5 wherein said tungsten polymer has a density between 9-11 g/cc.

7. The collimator of claim 5 wherein said tungsten polymer has a density of 10 g/cc.

8. The collimator of claim 1 wherein said collimator comprises at least one of a slat, a parallel hole, a pinhole, a multi-pinhole, a square hole, a hexagonal hole, a fan beam, a diverging and a converging beam collimator.

9. The collimator of claim 1 wherein said collimator has a thickness from 0.01 to 1.1 cm.

10. The collimator of claim 1 wherein said tungsten polymer collimator has a photon stopping power of from 0.5 to 50%.

11. The collimator of claim 4 wherein said tungsten polymer collimator is configured to stop photons having energy levels from 50 to 200 keV.

12. The collimator of 1 wherein when a photon has an energy of from 50 to 200 keV and a thickness of said tungsten polymer collimator is between 0.01 to 1.0 cm, the tungsten polymer collimator has a stopping power of from 0.5 to 50%.

13. The collimator of claim 1 wherein said collimator is non-toxic.

14. A method for fabricating a tungsten polymer collimator comprising:
mixing tungsten powder with polymer to form a tungsten polymer; and,
submitting said tungsten polymer to a polymer fabrication process so as to form said collimator.

15. The method of claim 13 wherein said polymer fabrication process comprises molding.

16. The method of claim 13 wherein said polymer fabrication process comprises extruding.

17. The method of claim 13 wherein said tungsten polymer comprises at least 50% of tungsten by weight.

18. The method of claim 13 wherein said polymer comprises nylon.

19. The method of claim 13 wherein said collimator comprises at least one of a slat, a parallel hole, a pinhole, a multi-pinhole, a square hole, a hexagonal hole, a fan beam, a diverging and a converging beam collimator.

20. A collimator for a nuclear imaging device comprising tungsten polymer, said tungsten polymer comprising at least 50% by weight of tungsten and said polymer comprising nylon, said tungsten polymer formed by mixing powdered tungsten with a polymer, said tungsten polymer having a density between 9-12 g/cc.
